(19) United States
(12) Patent Application Publication
(10) Pub. No.: US 2005/0173412 A1
(43) Pub. Date: Aug. 11, 2005

(54) Systems for heating wafers

(75) Inventors: Nobuyuki Kondou, Handa-city (JP); Yoshinobu Goto, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/016,979

(22) Filed: Dec. 20, 2004

(30) Foreign Application Priority Data
Jan. 14, 2004 (JP) 2004-6247

(51) Int. Cl. H05B 3/44

(52) U.S. Cl. 219/544

(57) ABSTRACT

A wafer heating system 1 has a substrate portion 2a having a mounting face 2c for mounting and heating a wafer “W” and a side wall portion 2b surrounding the side edge of the wafer “W”. The height “D” of the side wall portion 2b from the mounting face 2c is not smaller than the thickness “C” of the wafer “W”.

This application claims the benefit of Japanese Patent Application P2004-6247, filed on Jan. 14, 2004, the entirety of which is incorporated by reference.

### BACKGROUND OF THE INVENTION

1. Field of the Invention

The invention relates to a system for heating a wafer.

2. Related Art Statement

In a system for producing semiconductors, a ceramic heater has been provided for heating a wafer so as to deposit a semiconductor thin film on the wafer from gaseous raw materials such as silane gas by means of thermal CVD or the like. In this kind of heater, it is necessary to assure the uniformity of temperature on the heating face for preventing semiconductor defects, while maintaining the temperature on the heating face high. A ceramic heater is, however, produced by embedding a heating element inside of a ceramic substrate, to result in a some degree of distribution of temperature on the heating face.

A so called multi-zone heater is known as such ceramic heater. Such multi-zone heater has a ceramic substrate and inner and outer resistance heat generators made of a metal of a high melting point embedded within the substrate. Separate power supply terminals are connected to the respective heat generators so that electric power is applied independently on the respective generators. The inner and outer heat generators can be thus independently controlled.

According to JP-A 5-326112, a resistance heat generator of a ceramic heater is constituted by plural circuit patterns each made of a high melting point metal. The circuit patterns are so arranged that they may supplement one another's defect portions. For example, one of the patterns has a defect portion such as a folded portion or a returning portion. In this case, another circuit pattern is overlapped on or over the defect portion of the one pattern.

For example, in a heater to be used for heating semiconductor wafers, the temperature of the mounting face of the heater needs to be uniformly controlled over the entire surface. It is required that the heater satisfy a severe specification, for example, that the temperature measured on the mounting face is within ±5° C., of the average of the whole mounting face under a use condition.

### SUMMARY OF THE INVENTION

For example, a ceramic heater with an inner resistance heat generator is produced and an electrical power is supplied to the heat generator so that the average temperature of the mounting face reaches a target temperature. It is now provided that the temperature over the heating surface is within a desired range after the average temperature reaches a target temperature. Even in this case, however, the temperature distribution of the mounting face may be substantially changed after the heater is actually fixed in a chamber. It is proved that the tendency is more substantial as a target temperature of a wafer is elevated.

An object of the present invention is to provide a wafer heating system having a mounting face for mounting and heating a wafer, wherein the uniformity of temperature of the wafer can be improved.

The present invention provides a system for heating a wafer, comprising a substrate portion comprising a mounting face for mounting and heating a wafer, a side wall portion surrounding a side edge of the wafer mounted on the mounting face, and a heating element provided in at least one of the substrate and side wall portions. The substrate and side wall portions are heated with the heating element, and the side wall portion has a height “D” from the mounting face not smaller than the thickness “C” of the wafer.

The inventors have studied the cause of the above problem that it becomes more difficult to obtain desired temperature uniformity as a target temperature of a wafer is higher. As a result, a substantial portion of electric power supplied to the ceramic heater is not utilized for convection heating of a semiconductor wafer, which is a major purpose, resulting in a substantial heat loss from the heater to the outside thereof. The electric power supply to the heating element required for attaining a target temperature becomes large. It is thus difficult to attain uniform temperature distribution on the mounting face of the heater.

The heat loss from the heater, which is not utilized for the convection heating of the wafer, includes the followings.
(1) Thermal transmission from the heater substrate to atmosphere in a chamber
(2) Thermal conduction from the heater substrate to a cooling portion of an end of a shaft (a member for supporting the heater)
(3) Heat transfer by radiation from the heater substrate to members (for example, a gas supply plate or liner) in a chamber

Since the distance of the member in a chamber and heater is relatively small and the member has a low surface temperature, the effect (3) of the heat transfer by radiation toward the members in a chamber proved to be the largest.

The heat loss towards members in a chamber is more and more increased as a target temperature of the wafer is made higher.

The inventors have tried to provide a side wall portion surrounding the side edge of a wafer and having a height “D” from the mounting face not smaller than the thickness “C” of the wafer, so that the side wall portion is further heated. It is thereby proved that a reduction of temperature of a peripheral part of the wafer, which is a main cause of the deviation of temperature of the wafer described above, can be prevented. The present invention is based on the discovery.

These and other objects, features and advantages of the invention will be appreciated upon reading the following description of the invention when taken in conjunction with the attached drawings, with the understanding that some modifications, variations and changes of the same could be made by the skilled person in the art.

### BRIEF DESCRIPTION OF THE DRAWINGS

FIG. 1 is a cross sectional view schematically showing a heating system 1 according to an embodiment of the present invention.

FIG. 2 is a cross sectional view schematically showing a heating system 11 according to another embodiment of the present invention.

FIG. 3 is a cross sectional view schematically showing a heating system 15 according to still another embodiment of the present invention.

FIG. 4(a) is a diagram showing temperature distribution of a wafer “W” mounted on a heating system of the present invention at a target temperature of 600° C.

FIG. 4(b) is a diagram showing temperature distribution of a wafer “W” mounted on a heating system of a comparative example at a target temperature of 600° C.

### PREFERRED EMBODIMENTS OF THE INVENTION

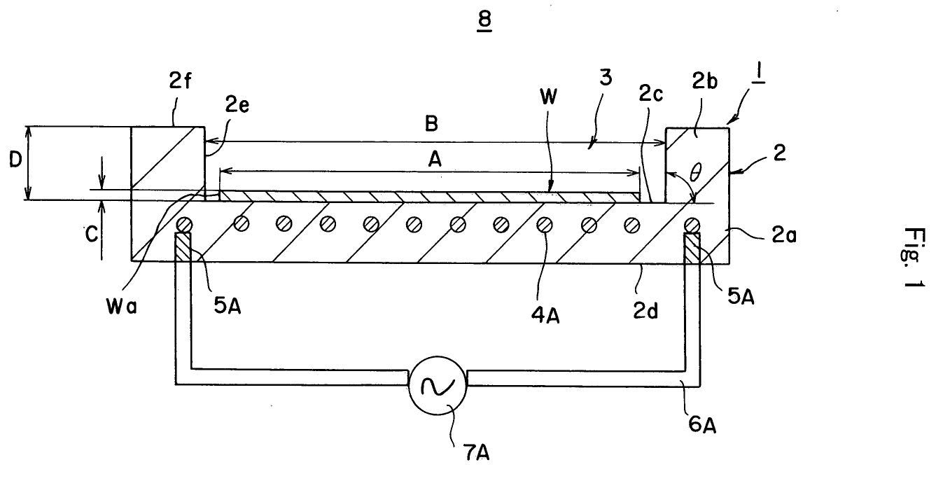

FIG. 1 is a cross sectional view schematically showing a heating system 1 according to an embodiment of the present invention. The heating system 1 of the present example has a disk-shaped substrate portion 2a and a side wall portion 2b protruding from the peripheral part of the substrate portion 2a. According to the present example, a heating element 4A is embedded in the substrate potion 2a, and connected to a power source 7A through a terminal 5A on a back face 2d of the substrate portion 2a and a cable 6A. A wafer “W” is mounted on a wafer mounting face 2c of the substrate portion 2a, directly or through another member, so that the wafer can be heated. A side wall portion 2b is provided on the peripheral part of the substrate portion 2a, so that the side wall portion 2b surrounds the wafer “W”. The side wall portion 2b has an inner wall surface 2e facing a side edge “Wa” of the wafer “W”. The height “D” of the side wall portion 2b from the mounting face 2c is not smaller than the thickness “C” of the wafer “W”. 8 represents a space inside of a chamber.

It is thus possible to reduce the heat transfer by radiation from the wafer “W” towards various members outside of the side wall portion, when the target temperature of the wafer “W” is made high, because heat radiated from the side edge of the wafer “W” is reflected by the side wall portion. Further, a part of calorific energy generated by the heating element 4A is transferred by convection to the side wall portion 2b so that the reduction of temperature in the side edge of the wafer “W” can be effectively prevented.

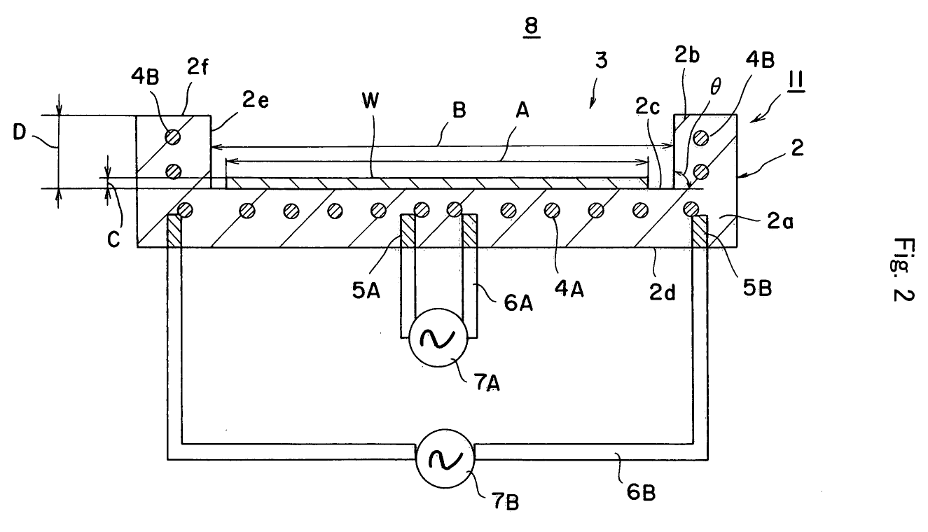

FIG. 2 is a cross sectional view schematically showing a heating system 11 according to another embodiment of the present invention. Parts already shown in FIG. 1 is referred to using the same numerals, and the explanation may be omitted.

The heating system 11 of FIG. 2 has a heating element 4B embedded in the side wall portion 2b. The heating element 4B is connected with a terminal 5B, which is connected to a power source 7B through a cable 6B. It is thus possible to generate heat from the heating element 4B to radiate heat from the inner wall surface 2e of the side wall portion 2b, so that the side edge “Wa” of the wafer “W” can be heated by radiation. The temperature distribution in the wafer “W” can thereby be further controlled.

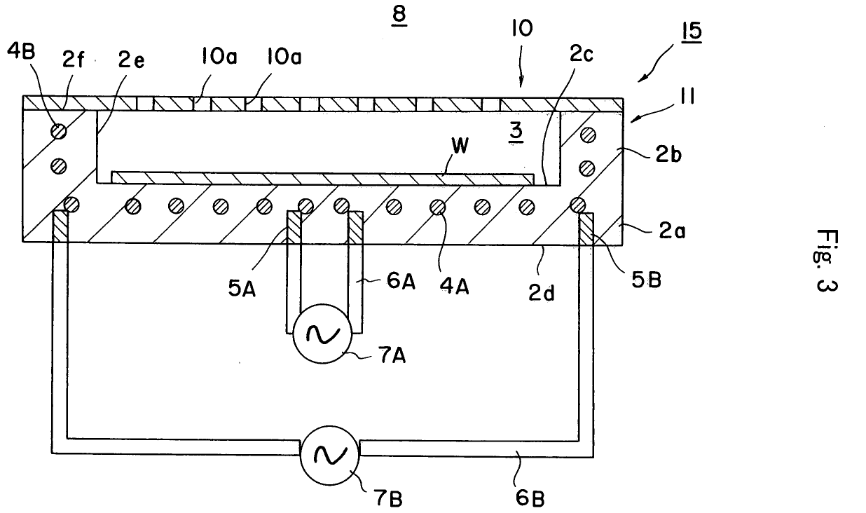

FIG. 3 is a cross sectional view schematically showing a heating system 15 according to still another embodiment of the present invention. Parts already shown in FIG. 1 is referred to using the same numerals, and the explanation may be omitted.

The heating system 15 of FIG. 3 is different from that of FIG. 2 in that a cover 10 is provided on a upper surface 2f of the side wall portion 2b. A space 3 is formed under the cover 10 and defined the mounting face 2c and inner wall surface 2e. The wafer “W” is contained in the space 3. According to the present example, it is possible to effectively prevent the deterioration of temperature uniformity of the wafer caused by heat transfer by radiation from the wafer “W” to the outside thereof.

According to the present invention, the height “D” of the side wall portion 2b from the mounting face 2c is not smaller than the thickness “C” of the wafer “W”. “D” may preferably be 1.1×C or larger and more preferably be 1.5×C or larger, on the viewpoint of improving the temperature uniformity of the wafer. If “D” becomes too large, however, the mounting of the wafer onto the mounting face 2c may be difficult. “D” may preferably be 50×C or smaller, and more preferably be 20×C or smaller, on the viewpoint.

The width “B” of the mounting face 2c should be not smaller than the width “A” of the wafer for containing the wafer in the space 3. On the viewpoint, “B” may preferably be larger than “A” and more preferably be 1.001×“A” or larger. On the other hand, “B” may preferably be 1.2×“A” or smaller and more preferably be 1.05×“A” or smaller, on the viewpoint of temperature uniformity of the wafer “W”.

The starting angle θ of the inner wall surface 2e of the side wall portion 2b with respect to the mounting face 2c may preferably be 30° or larger, and more preferably be 75° or larger, for further improving the temperature uniformity of the wafer “W”. Further, the starting angle θ may preferably be 135° or smaller, and more preferably be 115° or smaller, for the ease of handling, such as insertion of the wafer “W” into the space 3 and removal of the wafer “W”.

According to the present invention, the construction of the substrate portion of the heating system is not particularly limited. For example, the substrate portion has a disk shaped body made of an insulating material and a heating resistance embedded therein. Alternatively, a heating element may be provided on the back face of the disk shaped body made of an insulating material. The insulating material may preferably be a ceramics. Such ceramics may preferably be a nitride ceramics such as aluminum nitride, silicon carbide, silicon nitride, boron nitride, and sialon, and the other known ceramic materials such as alumina-silicon carbide composite material. Aluminum nitride and alumina are most preferred, for providing excellent anti-corrosion property against a corrosive gas such as halogen based gas. So-called sheath may be also used.

The emissivity (ε) of the substrate portion or side wall portion may preferably be small, for example, smaller than 0.8. Specifically, the material may preferably be whitish or glossy.

The shape of the substrate portion 2a is not particularly limited, and may preferably be disk shape. The mounting face 2c may be processed to form pockets, embosses or grooves on the face 2c. The method for producing the substrate portion 2a is not particularly limited, and may preferably be hot pressing or hot isostatic pressing.

The heating system of the present invention may be generally applied in a system for producing semiconductors. The system for producing semiconductors means systems usable in a wide variety of processes in semiconductor production. Such systems include film forming, etching, baking, curing, cleaning and testing systems.

A through hole is formed in the cover to be provided on the side wall portion for supplying processing gas and cleaning gas. The material for the cover is not particularly limited, and may be a nitride ceramics such as aluminum nitride, silicon carbide, silicon nitride, boron nitride and sialon, and the other known ceramic materials, such as alumina-silicon carbide composite material.

A shaft for supporting the substrate portion may be provided on the back face 2d of the substrate portion 2a. Further, electrodes for generating high frequency and electrostatic chucking may be embedded in the substrate and side wall portions. Further, the heating elements provided in the substrate and side wall portions may be controlled by so-called single zone control or multi-zone (for example dual-zone) control system.

The substrate and side wall portions may be made of an integrated object, and an integrated sintered body in this case. Further, the substrate and side wall portions may be separate bodies. In the latter case, the substrate and side wall portions may be joined with each other. Alternatively, the substrate and side wall portions may be fixed with each other by physically fastening them with a faster such as a screw.

The shape of the heating element 4A or 4B may be coil, ribbon, mesh, plate or film. Further, the material of the heating element may be a high melting point metal, such as tungsten and molybdenum, SUS, or an Ni-based alloy such as Incolloy and Hastelloy.

The center line average surface roughness Ra of the mounitng face 2c or inner wall surface 2e may preferably be 5.0 μm or smaller and more preferably be 1.0 μm or smaller. It is thus possible to further reduce the emissivity of each of the mounting face 2c and inner wall surface 2e.

### EXAMPLES

The heating system 11 shown in FIG. 2 was produced. The diameter “A” of a silicon wafer “W” was 300 mm and the thickness “C” was 1.7 mm. The substrate portion 2a and side wall portion 2b were made of aluminum nitride sintered body. The width “B” of the mounting face 2c was 301 mm. The height “D” of the side wall portion 2b was 8.0 mm according to the inventive example, and 0.5 mm according to a comparative example. The starting angle θ was 85° . The thickness of the substrate portion 2a was 10 mm. Heating elements 4A and 4B each having a shape of coil spring and made of molybdenum were embedded in the substrate portion 2a and side wall portion 2b, respectively. Terminals 5A and 5B were made of molybdenum.

The temperature of the heating system was elevated to change a target temperature for the wafer “W” as shown in table 1. The target temperature was confirmed with a thermocouple. The temperature distribution of the wafer “W” was observed with a thermoviewer. A difference between the maximum and minimum temperatures in a plane of the wafer “W” was calculated and shown in table 1.

TABLE 1

| Target | | |
|---|---|---|
| Temperature | D = 8 mm | D = 0.5 mm |
| 200° C. | 4.4° C. | 5.2° C. |
| 300° C. | 3.6° C. | 4.1° C. |
| 400° C. | 2.6° C. | 2.6° C. |
| 500° C. | 3.8° C. | 4.6° C. |
| 600° C. | 5.2° C. | 7.4° C. |
| Range | 2.6° C.˜5.2° C. | 2.6° C.˜7.4° C. |

As can be seen from the above results, according to the present invention, the temperature uniformity of the wafer “W” was proved to be excellent over a wide range of target temperatures. In particular, the deterioration of temperature uniformity can be prevented even when the target temperature was 500° C. or higher, according to the present invention.

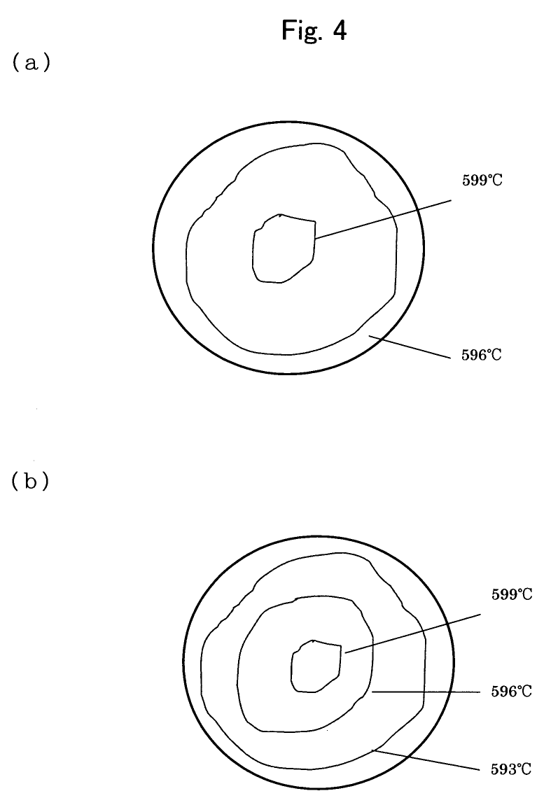

Further, FIG. 4(a) is a diagram showing temperature distribution of the wafer “W” mounted on the heating system according to the present invention at a target temperature of 600° C. FIG. 4(b) is a diagram showing temperature distribution of the wafer “W” mounted on the heating system according to the comparative example at a target temperature of 600° C. According to the present invention, the temperature distribution in radial direction was clearly reduced.

Additional inventive examples were carried out according to the procedure as the above described inventive example, except that the height “D” of the side wall portion 2b was changed to 1.7 mm, 2.0 mm or 5.0 mm. In each of the additional inventive examples, the results were similar to those of the above inventive example.

The present invention has been explained referring to the preferred embodiments. However, the present invention is not limited to the illustrated embodiments which are given by way of examples only, and may be carried out in various modes without departing from the scope of the invention.

1. A system for heating a wafer, comprising a substrate portion comprising a mounting face for mounting and heating a wafer, a side wall portion surrounding a side edge of said wafer mounted on said mounting face, and a heating element provided in at least one of said substrate portion and said side wall portion, wherein said substrate portion and said side wall portion are heated with said heating element, and wherein said side wall portion has a height “D” from said mounting face not smaller than the thickness “C” of said wafer.

2. The heating system of claim 1, wherein said heating element is provided in said side wall portion.

3. The heating system of claim 2, wherein said heating element is embedded in said side wall portion.

4. The heating system of claim 2, wherein said heating elements are provided in said side wall portion and said substrate portion, and wherein said heating element provided in said side wall portion has a heat generating density larger than that of said heating element provided in said substrate portion.

5. The heating system of claim 1, further comprising a cover for covering said wafer, wherein said cover comprises a through hole formed therein.

6. The heating system of claim 1, wherein said substrate portion and said side wall portion comprise separate bodies.

7. The heating system of claim 1, wherein said substrate portion and side wall portion comprise one integrated body.

8. The heating system of claim 1, wherein said substrate portion or said side wall portion comprises at least one of an electrode for generating high frequency and an electrode for electrostatic chuck.

9. The heating system of claim 1, wherein two or more heating elements are provided in said substrate portion or said side wall portion for multi-zone control.

10. The heating system of claim 2, further comprising a cover for covering said wafer, wherein said cover comprises a through hole formed therein.

11. The heating system of claim 2, wherein said substrate portion and said side wall portion comprise separate bodies.

12. The heating system of claim 2, wherein said substrate portion and side wall portion comprise one integrated body.

13. The heating system of claim 2, wherein said substrate portion or said side wall portion comprises at least one of an electrode for generating high frequency and an electrode for electrostatic chuck.

14. The heating system of claim 3, further comprising a cover for covering said wafer, wherein said cover comprises a through hole formed therein.

15. The heating system of claim 3, wherein said substrate portion and said side wall portion comprise separate bodies.

16. The heating system of claim 3, wherein said substrate portion and side wall portion comprise one integrated body.

17. The heating system of claim 3, wherein said substrate portion or said side wall portion comprises at least one of an electrode for generating high frequency and an electrode for electrostatic chuck.

18. The heating system of claim 3, wherein two or more heating elements are embedded in said substrate portion or said side wall portion for multi-zone control.
